(19) United States
(12) Patent Application Publication
(10) Pub. No.: US 2006/0202989 A1
(43) Pub. Date: Sep. 14, 2006

(54) Systems and methods to optimize volumetric rendering of a region of interest ("Tension Vectors")

(75) Inventor: Freddie Wu Yinghui, Singapore (SG)

Correspondence Address: KRAMER LEVIN NAFTALIS & FRANKEL LLP, INTELLECTUAL PROPERTY DEPARTMENT, 1177 AVENUE OF THE AMERICAS, NEW YORK, NY, 10036, US

(73) Assignee: Bracco Imaging, S.p.A., Milano (IT)

(21) Appl. No.: 11/372,705

(22) Filed: Mar. 10, 2006

Related U.S. Application Data
(60) Provisional application No. 60/660,604, filed on Mar. 10, 2005.

(51) Int. Cl. G06T 17/00

(52) U.S. Cl. 345/424

(57) ABSTRACT

Systems and methods for the optimization of volume rendering of a region of interest in a 3D data set are presented. In exemplary embodiments of the present invention, a method of optimizing the volume rendering of a 3D data set comprises dividing a region of interest into a set of blocks S, computing a tension vector for each block, translating each block as a function of its respective tension vector, and removing any empty blocks to create a new set of blocks S′, with lesser voxels to render. In exemplary embodiments of the present invention this process can be iterated until some defined condition occurs, and the region of interest can then be rendered using S′.

### CROSS-REFERENCE TO RELATED APPLICATIONS:

This application claims the benefit of United States Provisional Patent Application No. 60/660,604, entitled “System and Method to Optimize Volumetric Rendering of a Region of Interest (“Tension Vectors”)”, filed on Mar. 10, 2005, under common assignment herewith, which is hereby incorporated herein by this reference.

### TECHNICAL FIELD

The present invention relates to volume rendering, and more precisely to a system and method for reducing the data processing required to volumetrically render a given region of interest.

### BACKGROUND OF THE INVENTION

Volumetric rendering provides high-quality virtual views of complex three-dimensional structures. However, the speed of volumetric rendering is generally slow due to the large amount of data required to be processed. Conventional methods attempt to alleviate the problem either with various techniques such as incremental rendering, resorting to alternative visualization techniques of lower algorithmic complexity or methods involving data preprocessing. These conventional techniques are next described.

Incremental Rendering

Incremental rendering refers to a class of techniques that produce a final rendering result in multiple passes or steps. For example, a classic method of incremental rendering is to first produce a coarse (i.e., lower resolution) output which does not appear as nice as a finer output, but which can be rendered more quickly. Subsequently, if the rendering algorithm determines that a better output is still possible (e.g., if the hardware is free enough before the next frame is due), it can then continue and produce a finer (i.e., high resolution) output. Otherwise, if the hardware is not fast enough (and thus is not available prior to having to render the next frame), the algorithm can simply skip the finer output, and go on to render the next frame instead.

The advantage of incremental rendering lies mainly in the perceptually “faster” response from the system. However, the output a user sees falls in one of the following two scenarios: (i) if the hardware is fast enough, the rendering result keeps switching between low and high resolution frames; or (ii) if the hardware is not fast enough, the rendering result consists of only low-resolution frames. If the user wishes to see a high-resolution result, he must pause for a while, ceasing all interaction with the data set, until the hardware can catch up and render a high-resolution frame. Either of these two scenarios can be quite annoying to a user who is interactively inspecting a three-dimensional volumetric model.

Alternative Visualization Techniques for Volumetric Data

Conventionally, there are a number of classic alternatives to volumetric rendering for the visualization of three-dimensional volumetric models. These include, for example, isosurface rendering and triplanar visualization. An isosurface is a three-dimensional surface that passes through all voxels having a given value in a three-dimensional volumetric model. Generally, tools are provided that allow a user to interactively adjust the isovalue (the voxel value that an isosurface passes through) so as to better understand the volumetric model as a whole. FIG. 1(a), for example, depicts an exemplary CT scan data set with an isosurface set to approximate the patient's skin.

Because an isosurface is usually represented by a mesh structure, which consists of numerous small polygonal surfaces, the amount of data to be rendered on screen is significantly reduced. Furthermore, isosurface generation is a lot less computationally complex given the highly optimized polygon rendering capabilities of modern graphics hardware.

However, solely using isosurface rendering to display a 3D object suffers from loss of information due to the reduction of a three-dimensional volumetric data set to a two-dimensional surface mesh structure. Further, it is less intuitive to visualize an entire object within a volumetric data set by adjusting the isovalue of the isosurface and successively visualizing different layers.

Another alternative method is triplanar visualization. Triplanar visualization makes use of three mutually orthogonal planes cutting through a volume, and renders the three intersection planes. Tools are usually provided to allow a user to interactively adjust the positions of the three orthogonal planes. As an example, FIG. 1(b) depicts the CT scan data set of FIG. 1 (a) shown in triplanar mode.

Similar to the problem that isosurface rendering faces, triplanar visualization also suffers from a loss of information. To medical imaging interpretation specialists such as, for example, radiologists, triplanar visualization may sometimes be sufficient inasmuch as they have been trained to visualize volumetric data by looking at individual slices and mentally merge them into a whole. It is, nonetheless, difficult for a normal user to visualize a volumetric model using just planar slices.

Other Methods Recently it has been proposed to compress a volumetric data set using a mathematical formulation. In such a method parts of a volumetric data set are preprocessed and stored with the compressed volume. During volume rendering, these systems seek to dynamically determine the parts of the volume necessary to decompress. Such systems attempt to make use of the preprocessed data to reduce the amount of computations required for gradient values. For example, it has been proposed to use wavelet-compression, a multi-level compression algorithm, for this purpose. For example, a volume of size 128×128×128=2,097,152 voxels can be processed to produce a smaller block of 64×64×64=262,144 voxels. Such a compressed block has a lower resolution than the original one, so it renders much faster. When high-resolution rendering is required, the wavelet property allows reconstructing the volume with the original resolution by loading certain parameters that describe the difference between the low-resolution volume and the original volume. Similarly, other voulmetric optimization methods involve some type of preprocessing so as to transform the original volume data into a format suitable for the specific optimization technique.

While the above described techniques may suffice if the volume data is only to be visualized, if the volume data is to be interacted with, operated on, or modified, this method can be problematic if the original volume data has been transformed into another format. Further, volume compression/decompression algorithms require very careful designs, as they must be fast and efficient, and should not produce any visible distortion to a final rendering result. This minimal distortion requirement is even more stringent for the visualization of medical data, inasmuch as artifacts and distortion can result in a mistaken diagnosis. For example, given an original abdominal CT scan data set of a patient with 512×512×512=134,217,728 voxels, upon performing downsampling to 256×256×256=16,777,216 voxels and visually inspecting both volumes, it was seen that certain fine structures in the patient's colon simply vanished, even though 256³ is still considered to be a high-resolution volume. If such structures represent clinical significance, the difference in visualization can obviously result in a serious misdiagnosis.

Direct Volume Rendering

In contrast to the above described techniques is direct volume rendering. Direct volume rendering is so named because it does not make use of secondary information (such as isosurfaces or planar slices) for visualization. As an example, FIG. 1(c) is a depiction of the CT data set of FIG. 1(a) visualized by direct volume rendering using a translucent transfer function.

Direct volume rendering displays a 3D model in an intuitive manner that does not require intensive training to interpret. However, the huge amount of data generally required to be processed in direct volume rendering is the major hurdle to using this method of visualization.

As is known in the art of volume rendering, the more voxels that must be rendered and displayed, the higher the demand on computing resources. The demand on computing resources is also proportional to the level of detail a given user chooses, such as, for example, by increasing digital zoom or by increasing rendering quality. If greater detail is chosen, then a greater number of polygons must be created in sampling the volume. When more polygons are to be sampled, more pixels are required to be drawn and, because in general, each pixel on the screen will be repeatedly filled many times over the fill rate will correspondingly be decreased. At high levels of detail such a large amount of input data can slow down the rendering speed of the viewed volume segment to such an extent that a user may have to wait for the displayed image to fill, such as, for example, after moving the viewpoint to a new location.

Notwithstanding the costs of providing it, greater detail is generally desired, and is in fact often necessary, to assist a user in making a close diagnosis or analysis of a 3D data set. This is especially so when medical diagnoses are to be made on the basis of the visualization of scan data in a virtual examination, such as, for example, in virtual colonoscopy, or, for example, when evaluating scan data of inaccessible anatomical areas, such as, for example, in the diagnosis of brain tumors and in the planning of procedures to remove them.

In fact, as scan technologies provide the capability to acquire more scan slices at greater pixel resolutions per slice, these specifications tend to become a de facto standard which 3D visualization systems need to keep up with to remain current. Because volumes grow in voxels at a much greater pace than scan images grow in pixel resolution (not to mention the further upward pressure on volume size due to more and more slices per data set being commonly used), this problem will only exacerbate as time goes on.

Additionally, if depth cues are desired, such as, for example, by rendering a volume of interest stereoscopically, the number of sampled polygons that must be input to rendering algorithms doubles, and so, accordingly, does the memory required to do the rendering.

Rendering Effects—Further Degradation of Performance

In general, the addition of rendering effects also increases the amount of computing resources required. For example, in order to compute spectacular lighting effects, the underlying physics and mathematical models require the computation of gradients of the grayscale values at each voxel. In order to store this additional gradient data, three times as much additional memory can be needed as is required by the original volume. For example, in a system that uses eight bits to store each value, the original volume has 8 bits per voxel. After gradient computation, it is necessary to store, besides the original voxel value, an <x, y, z> vector for each voxel to represent the gradient value. Given that x, y, and z components are, for example, each 8 bits in size themselves, this results in three times more memory used as compared to storing just the original voxel value.

Besides the requirements of a quadruply larger memory, it is, in general, also expensive to compute the gradient data. A relatively simple way to compute such gradients for a single arbitrary point in space can involve reading and interpolating eight neighboring voxels at the same time. Because screen resolution is not usually equal to the volume resolution, in order to find the color of a pixel on screen, the corresponding location in 3D space may not fall exactly onto any single voxel—it is usually somewhere between voxels. Thus, in order to estimate the value at such locations, 8 nearest voxels to the arbitrary location must be accessed to perform, for example, a trilinear interpolation such as is commonly used in graphics rendering.

Therefore, adding shading to 3D texture-based direct volume rendering is expensive both in terms of memory consumption and computational complexity.

In general, the above-described problems of conventional methods are common to all situations where a user interactively views a large 3D data set one portion at a time, where the portion actually being viewed at any one time is only a small fraction of the entire data set. Unless this fact is somehow ameliorated, such interactive viewing is prone to useless processing of voxels which are never actually displayed, thus diverting needed computing resources from the processing and rendering of those voxels that are being displayed. This can introduce, amongst other difficulties, slow system response and wait states.

What is thus needed in the art are systems and methods to optimize the process of displaying large 3D data sets where at any given time the portion of the volume being inspected is only a small subset of the entire volume. Such optimizations, by removing the burden on the system of processing voxels not of interest to the viewer, can allow display systems to more efficiently utilize computing resources. As a result, such systems can facilitate seamless no-wait state viewing even with the use of depth cues and greater detail, as well as the free use of tools and functionalities at high resolutions that require large numbers of calculations for each rendered voxel.

### SUMMARY OF THE INVENTION:

Systems and methods for the optimization of volume rendering of a region of interest in a 3D data set are presented. In exemplary embodiments of the present invention, a method of optimizing the volume rendering of a 3D data set comprises dividing a region of interest into a set of blocks S, computing a tension vector for each block, translating each block as a function of its respective tension vector, and removing any empty blocks to create a new set of blocks S′, with lesser voxels to render. In exemplary embodiments of the present invention this process can be iterated until some defined condition occurs, and the region of interest can then be rendered using S′.

### BRIEF DESCRIPTION OF THE DRAWINGS:

FIGS. 1 (a)-(c) depict various methods of displaying an exemplary 3D data set;

FIG. 2 illustrates an exemplary Region of Interest (“ROI”) within a volume generated from an exemplary MRI scan of a human head;

FIG. 3 illustrates an exemplary Region of Interest within a volume generated from an exemplary CT scan of a human colon;

FIG. 4 illustrates viewpoint-dependent ROI optimization;

FIG. 5 depicts exemplary axis-aligned and non axis-aligned blocks;

FIG. 6 is an exemplary process flow chart of an optimization method according to an exemplary embodiment of the present invention;

FIG. 7 illustrates exemplary tension vectors and their components in 2D;

FIG. 8 illustrates exemplary tension vectors associated with each of four exemplary blocks of a Region of Interest according to an exemplary embodiment of the present invention;

FIG. 9 depicts the four blocks of FIG. 8 after translation according to an exemplary embodiment of the present invention;

FIG. 10 illustrates an exemplary optimization result after translation of the blocks depicted in FIG. 8 and removal of redundant blocks according to an exemplary embodiment of the present invention;

FIG. 11 illustrates an exemplary optimization of a tube-like structure after one iteration according to an exemplary embodiment of the present invention; and

FIG. 12 illustrates two exemplary voxel blocks with associated “propelling vectors.”

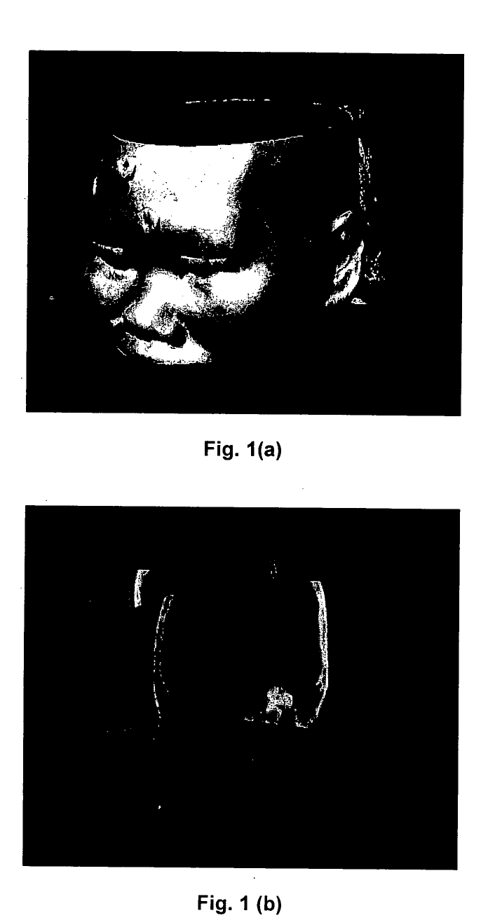

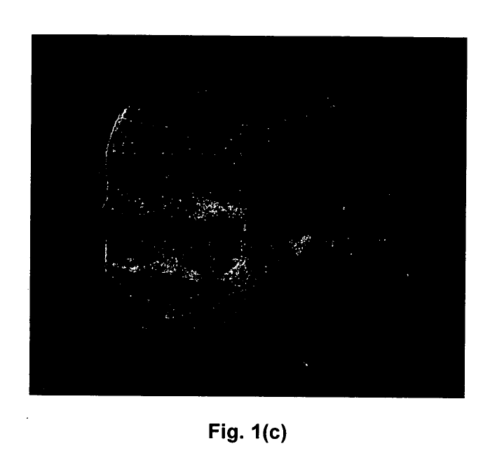

It is noted that the patent or application file contains at least one drawing executed in color. Copies of this patent or patent application publication with color drawings will be provided by the U.S. Patent Office upon request and payment of the necessary fee.

### DETAILED DESCRIPTION OF THE INVENTION

As opposed to conventional techniques that compromise the quality of volume rendering, in exemplary embodiments of the present invention the volume rendering process can be accelerated by extracting from the original volume only that data which is within a Region of Interest (“ROI”). In such exemplary embodiments, the rendering process can safely ignore the rest of the data, thus significantly decreasing the voxels that need to be rendered. Moreover, an optimization algorithm according to the present invention can further improve rendering performance by dividing the data in an ROI into small blocks, where each of which can easily fit into the texture memory of graphics acceleration hardware. This approach can, for example, not only drastically reduce the amount of data necessary to be processed by the rendering pipeline, but it can, for example, also allow full utilization of the underlying graphics acceleration hardware for fast volumetric rendering.

In order to adequately illustrate the methods of exemplary embodiments of the present invention, certain details of volume rendering systems are first described.

Graphics Hardware and Texture Memory

Modern workstation-class graphics hardware usually has 256 MB to 512 MB of on-board memory. Soon it will be an even higher value. This memory is mostly used as texture memory when hardware-intensive rendering is required. Although modern graphics hardware generally has very high bandwidth for data transfer from main memory (as much as 2 GB/sec for high-end systems), the actual effective bandwidth is a lot lower due to delays in accessing the main memory as well as to congestions in the computer's data channels. Further, many current volumetric models can easily exceed the size of the texture memory. For example, it is not uncommon for neuroradiologists to routinely perform CT scans that result in volumes of the dimension of 1024×1024×1024, or 1 G voxels. What is worse, is that such scans are often performed using 16-bits per voxel, which results in a raw volume model of 2 GB bytes in size. Additionally, other graphics components in a system can also use up part of the precious texture memory, such as, for example, buttons, geometries, and graphics drivers.

Another problem with using up texture memory is the following. When the available texture memory in the graphics hardware is used up, the graphics system has to swap part of it into the main memory for temporary storage, so that it can make room for the additional data. With the frequent rendering of an interactive application, part of the texture memory will be continuously swapping between the graphics memory and the main memory, which can slow down the rendering by orders of magnitude.

Finally, modern graphics hardware does not handle large 3D texture blocks well. In fact, a block size of 128×128×128 is usually optimum. This is because if the 3D texture blocks are too small, a single volume object will involve too many texture blocks, thus incurring greater texture loading overhead. Alternatively, if the 3D texture blocks are too large, the graphics hardware will handle them very slowly, as compared to smaller blocks.

A volume is a three-dimensional array of volumetric elements, or voxels. Each voxel in a given volume can be a scalar or a vector. For ease of description it is assumed herein that each voxel is a scalar. However, in general, voxels can be a vector of any dimension.

Region of Interest (“ROI”)

When visualizing a volume, generally only a certain region is actually of interest to a user at any one time. This is known as a Region of Interest (“ROI”). The ROI consists of only a portion of the entire volume. By making use of this fact, in exemplary embodiments of the present invention volumetric rendering processing can be substantially accelerated by ignoring any voxel that is outside of a ROI.

Thus, for example, if a given block contains at least a single ROI voxel, it cannot be safely ignored without compromising the final rendering. However, even after ROI optimization, the resultant “necessary” blocks may not all be used at all times. For example, if a user digitally zooms into a small part of the volume, only those ROI blocks that are visible in the zoomed view need to be rendered.

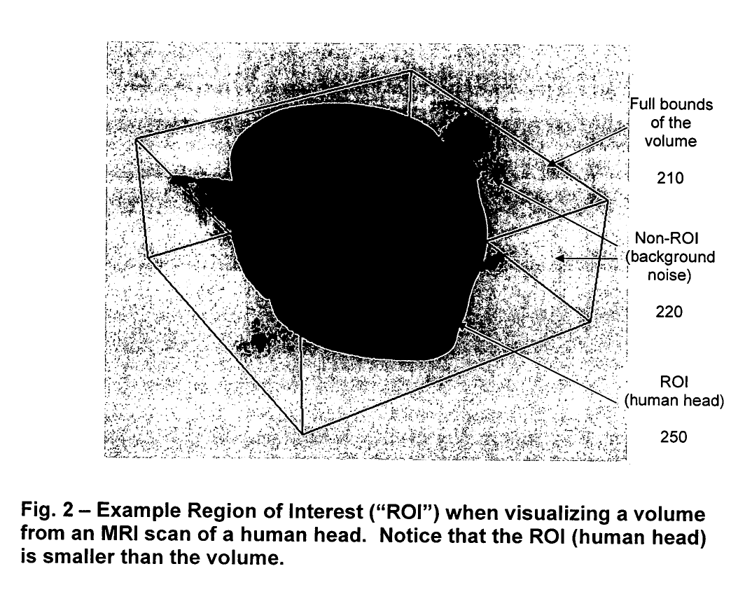

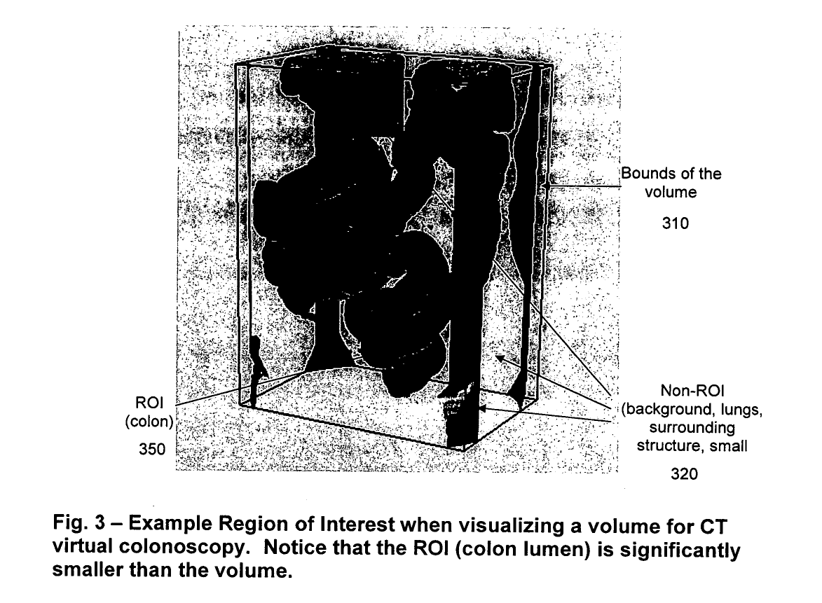

The exact definition of an ROI thus depends on the application that the volumetric visualization is being used for. In methods according to exemplary embodiments of the present invention it is simply assumed that the size of an ROI of a volume is smaller than the overall size of the volume. Thus, methods according to exemplary embodiments of the present invention can be used to optimize various applications that may respectively define a ROI using various criteria. For example, two exemplary ROIs for different medical imaging applications are depicted in FIGS. 2 and 3, the former for a neurological examination and the latter for a virtual colonoscopy.

In general, a volumetric ROI such as a colon lumen usually consists of only about 5% to 25% of the total voxels in the associated scan volume, and an ROI such as a human head consists of about 10% to 30% of the total voxels in the corresponding scan volume.

In order to amortize the cost of performing an optimization with respect to each viewpoint in a three-dimensional space, an ROI of a volume can be defined to include all voxels that are to be visualized in each possible viewpoint. Thus, an ROI optimization can be performed as a separate preprocessing step, thus avoiding the computational overhead of optimization per viewpoint.

For example, in exemplary embodiments of the present invention, an ROI optimization can be done as follows. It is assumed that a volumetric model is to be viewed from a specific viewpoint. It is further assumed that due to occlusion, parts of the object towards the far end are blocked by the parts in front. Therefore, if ROI optimization is to be performed for each viewpoint at runtime (since a user can interactively change his viewpoint at runtime), an optimization algorithm should be able to not only remove non-ROI voxels but to also remove ROI voxels that are completely occluded by other ROI voxels.

However, in practice, ROI optimization is itself a relatively expensive procedure; it is thus not always feasible to perform it at runtime. Therefore, in alternate exemplary embodiments of the present invention, ROI optimization can, for example, be done as a preprocessing step. Since in such an exemplary method the optimization is precomputed, it cannot be possible to predict what viewpoints a user will choose. Thus, in such, exemplary embodiments viewpoint-dependent optimization can be omitted, thus saving computational overhead.

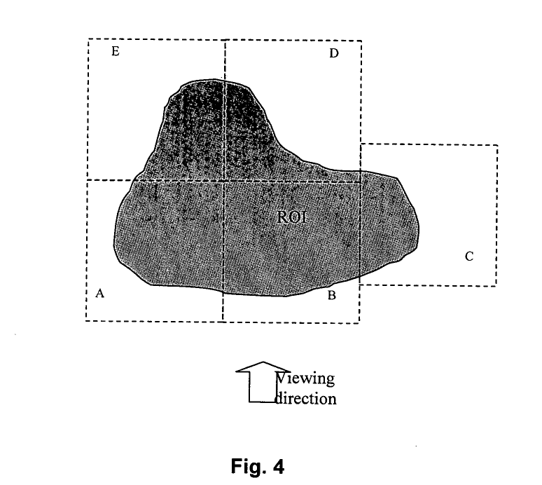

FIG. 4 illustrates the costs/benefits of viewpoint optimization. With viewpoint information, for example, an exemplary ROI optimizer can remove blocks D and E, as they will be completely occluded from the user's point of view by blocks A, B, and C. Without viewpoint information, however, blocks D and E cannot be safely ignored, as a user may choose to view the ROI from the opposite direction.

As noted, in exemplary embodiments of the present invention ROI optimization can be performed with the assumption that a user may choose a viewpoint from any direction. Thus, in such embodiments only non-ROI voxels can be removed without consideration of possible viewpoint-dependent visual occlusions.

The ROI of a volume can, for example, be algorithmically defined as a binary voxel mask of exactly the same dimension as the volume. A ‘1’ in the binary mask can, for example, indicate that the corresponding voxel in the volume is inside the ROI, while, for example, a ‘0’ can indicate otherwise. In general an ROI is obtained via segmentation, using known techniques, and is often application, as well as knowledge domain/anatomical area of interest, specific.

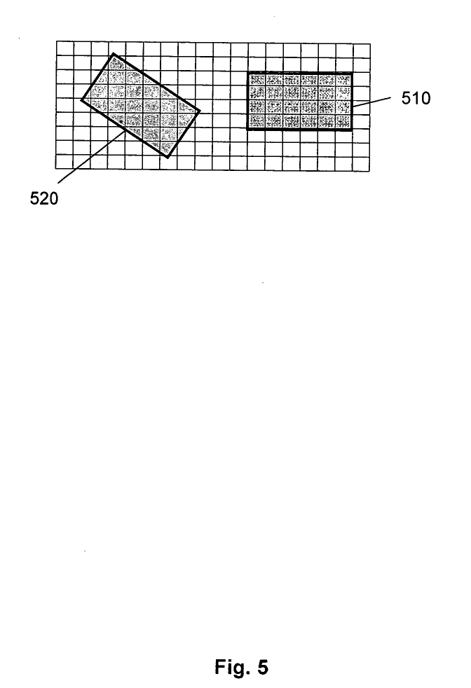

In exemplary embodiments of the present invention the removal of redundant voxels can, for example, be done in “blocks.” For example, each block can be defined as an axis-aligned cuboid of voxels within the volume. The axis alignment of the blocks can, for example, be imposed to avoid unnecessary interpolations during the optimization process. As is illustrated in FIG. 5, for example, a non-axis aligned block can contain a lot of partial voxels from the original volume near its boundary. Since these boundary voxels cover less space than a normal voxel, their intensities used in the actual rendering cannot be the same as the original voxel. Thus, interpolations are needed, which can be avoided by using axis-aligned blocks. Further, the grid orientation in a non-axis aligned block is generally different than that of a bounding box, which fact also requires interpolations when the block is used for rendering (inasmuch as, generally, hardware can only handle cases where voxels are aligned with its bounding box). Without loss of generality, for ease of illustration it is assumed herein that each block is of the same size, d, in all dimensions. Thus, each block contains d³ voxels. It is noted that in a case where voxel dimensionality is not uniform, that is, where a voxel has different width, height or length, in order to keep the block's physical dimensions, actual voxel counts in each of the three dimensions may be different. For ease of illustration herein it is assumed that voxels are simply regular cubes where width=height=breadth.

Non-Axis-Aligned Blocks

Non-axis-aligned blocks may in fact work better in terms of their effectiveness in excluding non-ROI voxels. However, in order to determine whether a voxel is within the ROI or not, one usually has to inspect some properties of the voxel. FIG. 5 illustrates examples of an axis-aligned as well as of a non axis-aligned block.

For the axis-aligned block 510 on the right of the figure, it can be is easily determined if a voxel is within bounds, as all of the boundaries encompass grid points. However, for the non-axis-aligned block 520 on the left, it is not well-defined if the boundary voxels should be considered as within the block or what value shall they take when only a part of a voxel is actually inside the block. Thus, in order to handle the uncertainty of partially contained voxels, mathematical interpolation is usually required, which is a lot more computationally expensive than is the case with axis-aligned blocks. For example, if a voxel is partially contained in a bounding box, say, for example, 50% of it is within the box, a system will have to treat its intensity as 50% of its original value during computation. Given that dealing with such percentages of partial voxel containment involve relatively complex geometric computations, it is often better to avoid dealing with them.

Tension Vectors

In exemplary embodiments of the present invention, each block can, for example, be associated with a three-dimensional tension vector, as is described more fully below. In exemplary embodiments of the present invention this tension vector can be used to optimize the data set for rendering by iteratively (i) minimizing the overall tension of all tension vectors, and (ii) removing empty blocks (i.e., blocks that contain no voxel belonging to the ROI) and overlapping blocks (i.e., for blocks that completely overlap one another, only one needs to be retained).

Minimization of Overall Tension

Intuitively speaking, minimizing the magnitude of a tension vector (the scalar “tension” of such a vector can be taken as its mathematical length) can be understood as equivalent to reducing the distance between the two objects causing the tension. In general, such objects can be a portion of an object or region of interest and the boundaries of a block containing it, as illustrated below.

In exemplary embodiments of the present invention, tension vectors can, for example, be computed between an ROI's tight bounding boxes and the unoptimized ROI blocks. A tight bounding box, as known in the art, is the smallest box that contains all of the portion of the ROI that is within a given block. Thus, minimizing tension is equivalent to moving the ROI blocks closer to the ROI itself. By squeezing all ROI blocks towards the object which is the ROI, some of the blocks eventually completely overlap one another. In this case, only a single ROI block from the set of overlapping ones need be retained, which further reduces the total number of ROI blocks required for rendering.

For ease of description, in what follows the present invention will be illustrated in 2D using two-dimensional slices. However, it is noted that the methods of exemplary embodiments of the present invention are generally performed in three-dimensional space, relating to the visualization of 3D data sets using volume rendering, and can be extended to higher dimensions as well, as may be needed in a given application. For example, a 4D data set consists of a sequence of 3D volumetric “frames.” When such “frames” are rendered in sequence, a moving 3D model can be seen. If only part of this whole time sequence is of interest, the methods of the present invention can be similarly applied in 4D space to cut down on the number of frames to actually render.

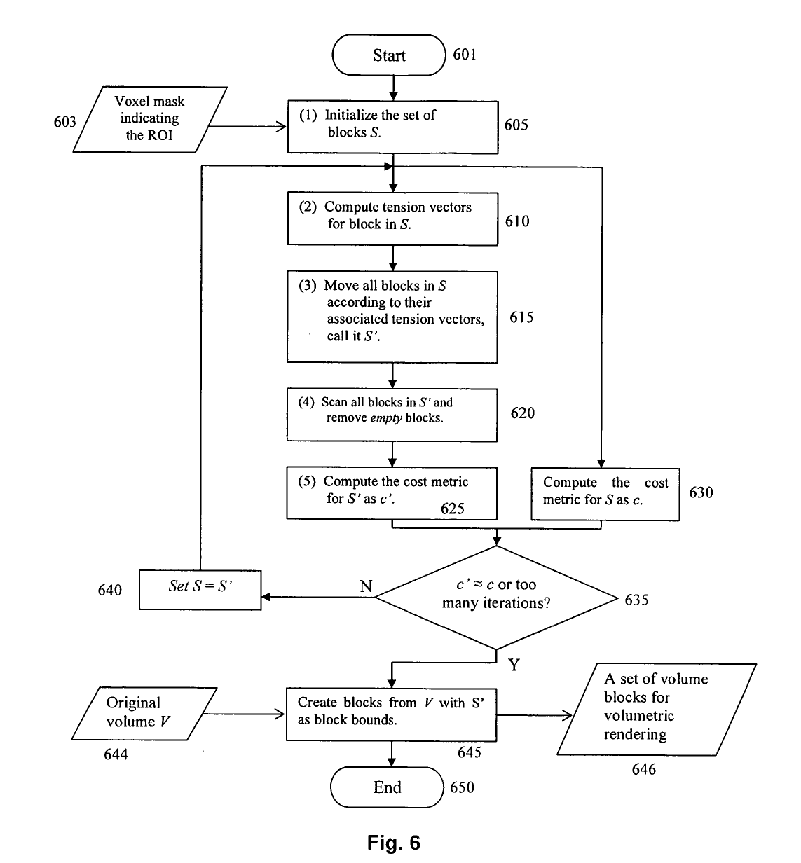

FIG. 6 depicts an exemplary process flow for an exemplary optimization algorithm according to an exemplary embodiment of the present invention. It is noted that the whole process is an iterative one, which can be terminated, for example, at 635 by either reaching a local minimum in the optimization cost metric c (N at 635), or having reached a “too many iterations” condition (Y at 635).

In exemplary embodiments of the present invention, three to five iterations can often be sufficient in achieving a near-optimal result. In many ROI types, further iterations may not significantly improve the result as compared to the required computation time.

With reference to FIG. 6, at 605 a set of blocks S can be initialized by slicing the entire voxel mask 603 into a regular grid, where each block's dimension d can be, for example, a function of the size of the underlying graphics accelerator's texture memory (e.g., d can be selected so that d³<size of texture memory).

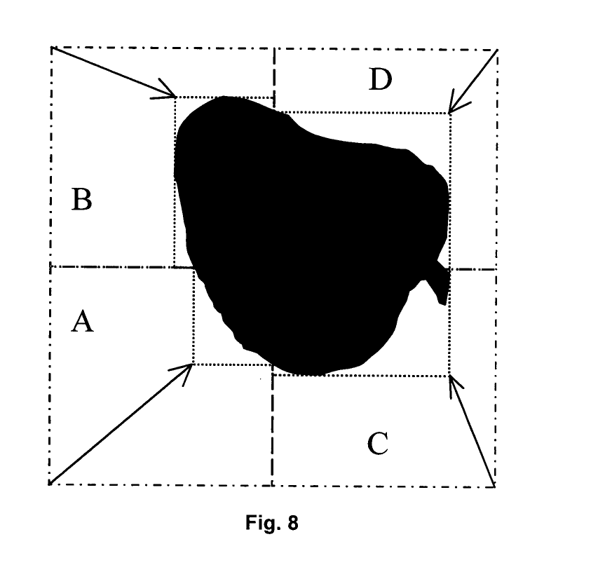

At 610, for example, the tension vectors for each block in S can be computed. Conceptually, tension vectors always point towards the center of an object of interest in the ROI as shown for the shaded purple object labeled “ROI” in FIG. 8 (tension vectors shown in red). However, in exemplary embodiments of the present invention, the actual magnitude and direction of a tension vector can be computed from an unoptimized block boundary (i.e., the black dash-dotted boxes in FIG. 8) to a tight bounding box (inside dotted blue line boxes in FIG. 8) for each block with an ROI component.

Given a calculated tension vector for each block in S, in exemplary embodiments of the present invention, at 615, each block can, for example, then be translated in the direction of its associated tension vector This can reduces the overall tension on each tension vector, which is effectively equivalent to reducing the empty space (i.e., the space between each outer black dash-dotted box and its corresponding blue dotted line inner box in FIG. 8) in each block. As noted, “tension” refers to the magnitude of the tension vector.

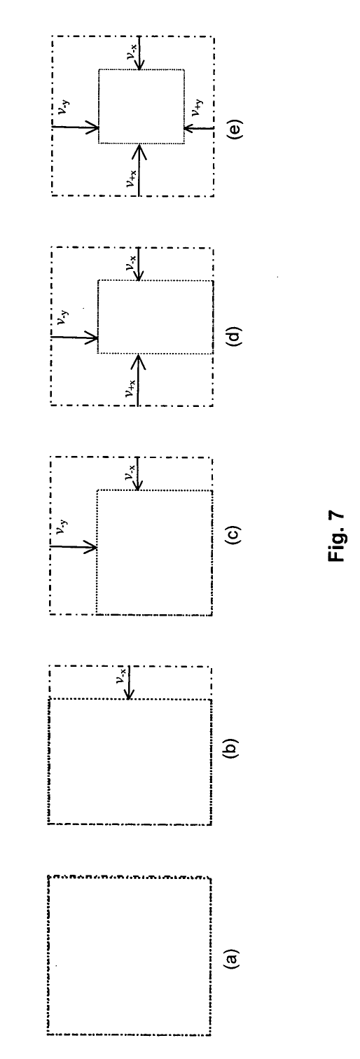

Tension vectors will next be generally described in connection with FIG. 7. FIG. 7 depicts an exemplary series of blocks shown with various sized tight bounding boxes either overlapping them or lying within them. In 2D, there are actually 4 axis-aligned component tension vectors, namely v₋ₓ, V₊ₓ, v_{+Y}, and v_{+y}, for each ROI block (and thus there are six component tension vectors in a 3D case). In general, for a space of N dimensions, there are 2N such component tension vectors. As is illustrated in FIG. 7, some of these vectors can, for example, be of magnitude 0, as when the corresponding side of an ROI block overlaps with that of a tight-bound box. This is the case, for example, for all of the component tension vectors in FIG. 7(a), for the v₊ₓ, v_{-y} and v_{+y} component tension vectors in FIG. 7(b), for the v₊ₓ and v_{+y} component tension vectors in FIG. 7(c), and for the v_{+y} component tension vector in FIG. 7(d). Mathematically, for example, a component tension vector along an axis can be defined, for example, as being parallel to that axis, pointing from an ROI box to a tight-bound box, and its magnitude can be defined to be the distance between the corresponding sides of the ROI box and the tight-bound box. The “final”, or overall, tension vector of a ROI block can be mathematically defined, for example, as the vector sum of all the component tension vectors.

In exemplary embodiments of the present invention, a final tension vector can, for example, be computed for each ROI block, as a 3D vector τ=<x, y, z>. In order to optimize an ROI block, such a block, can, for example, be translated from its previous position by τ. After translation, redundant blocks can be identified and removed, thus completing one iteration of an exemplary algorithm. In a subsequent iteration, a tight-bound box for each ROI block can be re-computed based on the ROI block's new position, and the tension vector computation can continue.

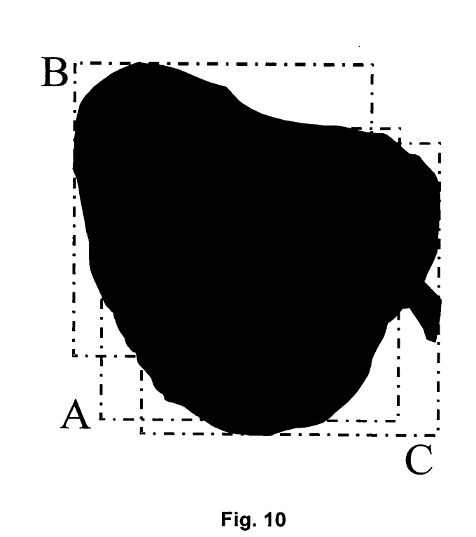

After translation of all blocks, in exemplary embodiments of the present invention, at 620, blocks that contain no voxel in the ROI at all, or blocks that contain only voxels of ROI that are already in the bounds of other blocks, can be identified. Such blocks can be regarded as empty (in the sense that they add no additional necessary voxels). After this calculation, by copying only the non-empty blocks from S into a new set of blocks S′, empty or redundant blocks that do not contribute to the volumetric rendering of the ROI can, for example, be effectively removed. As is illustrated in FIGS. 8-10, which depict a volume containing an exemplary ROI, the total number of blocks required to be processed has been reduced from 4 to 3 (redundant block D was removed form the final set of blocks as shown in FIG. 10) after such an optimization step according to an exemplary embodiment of the present invention.

In order to detect ROI blocks that overlap one another, in exemplary embodiments of the present invention, for example, a binary mask of the whole ROI can be created. An exemplary algorithm can first initialize the whole binary mask to 1's. Then, for example, it can scan through the optimized ROI blocks one after another, filling voxels in the binary mask that is contained by each ROI block with 0's. If, during this process, all the binary voxels contained by an ROI block are already all 0's, it is known that this ROI block either contains only non-ROI voxels, or overlaps completely with other ROI blocks. Thus, it can be removed.

Using this exemplary algorithm, both empty as well as completely overlapping ROI blocks can be identified in the same procedure. Moreover, such an algorithm guarantees that exactly one ROI block within each group of overlapping blocks will be kept. For example, the one that is first processed, as in the exemplary algorithm described above.

What is next described is a run through one iteration of an exemplary algorithm according to an exemplary embodiment of the present invention using the example ROI and set of blocks shown in FIGS. 8-10.

With reference to FIG. 8, the origin of the 2D data set is assumed to be the lower left corner of ROI block A. The following are the boundaries ((x,y) values of the upper left and lower right corners, respectively) for each of the blocks and tight bound boxes for blocks A-D, along with the associated tension vectors:

| | |
|---|---|
| ROI block A: (0, 10)-(10, 0) | Tight-bound of A: (7, 10)-(10, 6) |
| ROI block B: (0, 20)-(10, 10) | Tight-bound of B: (6, 18)-(10, 10) |
| ROI block C: (10, 10)-(20, 0) | Tight-bound of C: (10, 10)-(18, 5) |
| ROI block D: (10, 20)-(20, 10) | Tight-bound of D: (10, 17)-(18, 10) |

Tension vector for A=<7, 6>
Tension vector for B=<6, −2>
Tension vector for C=<−2, 5>
Tension vector for D=<−2, −3>

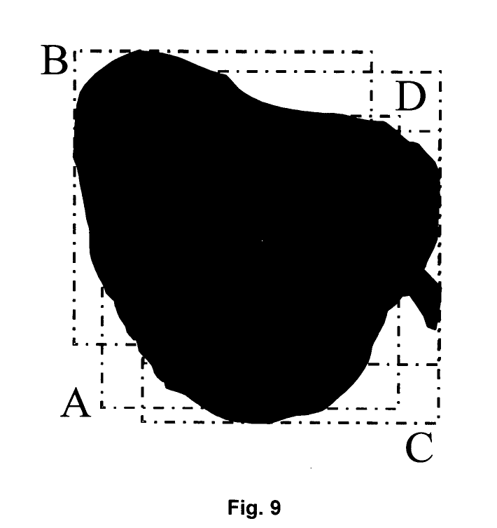

After ROI optimization, ROI blocks A, B, C, and D can be all translated by their respective tension vectors to obtain new positions for blocks A-D as shown in FIG. 9:
ROI block A: (7, 16)-(17, 6)
ROI block B: (6, 18)-(16, 8)
ROI block C: (8, 15)-(18, 5)
ROI block D: (8, 17)-(18, 7)

It is noted that as shown in FIG. 9 all ROI voxels contained in D are already included in blocks A, B, and C. Therefore, ROI block D becomes redundant, and can, for example, be removed, resulting in the new set of ROI blocks shown in FIG. 10. Such a new set of blocks can be called S′, where S refers to the original, or prior set of blocks, before processing using an optimization algorithm.

Cost Metrics

Returning again to FIG. 6, after each optimization iteration, at 625 and 630, the value of a cost metric for each of the initial set of blocks S and the resultant set of blocks S′ can be computed, so as to determine whether to continue to another iteration for further optimization. The cost metric can, for example, be as simple as the difference in the total number of blocks in the sets S and S′, or can be more elaborate, such as, for example, a score or index representing the total overlap between pairs of blocks in the two sets S and S′. In exemplary embodiments of the present invention a cost metric can be tuned, based, for example, on the nature of an ROI as is known prior to the optimization. I.e., cost metrics can be highly domain specific, and can, for example, be optimized to a particular ROI or class thereof using known data about the characteristics of the given ROI. For example, in applications directed to colonoscopy, simple metrics can be used that count the total number of blocks in use. In practice, while this metric may not produce an ideal optimal result, it does produce good-enough results that can provide a sufficient acceleration of rendering times on most data sets.

As can be observed from the 2D example described above, optimized ROI blocks often overlap one another, at least partially. One way to compute the total overlap is, for example, as follows. A volume can be created and all voxels in it initialized to 0's. For each optimized ROI block, for example, the voxels contained in it can be incremented by 1. Thus, areas covered by a single ROI block will have voxels of value 1, while areas covered by more than one ROI blocks will have voxels of value greater than 1. In fact, in this example, a voxel's final value equals to the total number of ROI blocks containing it.

In exemplary embodiments of the present invention the summed overlap can be defined as the sum of all voxel values in the resultant volume, which intuitively indicates how much overlap exists within the set of optimized ROI blocks. The greater this sum is, the more overlap there is, which is less desirable due to redundancy.

In exemplary embodiments of the present invention a simple cost metric can, for example, be to take the total number of resultant optimized blocks. The smaller this count is, the less data there are to process for rendering, thus the better the optimization result is. Thus, with reference to FIG. 6, at 630, as long as c′<c, optimization can, for example, be continued.

Additional Tuning

However, using the exemplary tension vector presented above tends to translate the ROI blocks as much as possible until they touch their respective tight-bound boxes. Therefore, more overlap is expected from the resultant optimized ROI blocks (i.e., they are all cramped towards the centre of the ROI). In this case, a simple ROI block count metric may not be sufficient, as it is also desirable to prevent excessive overlap created by the optimization process. Thus, in exemplary embodiments of the present invention fine-tuning can be done to adjust the metric negatively (i.e., worsening its overall score as first computed). For example, pairwise overlap counts can be used. Thus, for every pair of blocks, the number of voxels that overlap each other can be counted. The sum of all the overlap counts can be used as the metric, and thus the smaller this number, the less overlap there is.

Thus, In exemplary embodiments of the present invention, an overall metric can have a main term related to block minimization and a secondary term relating to block overlap. In exemplary embodiments a balance can be struck between these two terms to reach an optimal value or value range for the overall metric.

Moreover, in order to handle rare cases where the cost metric converges too slowly based on the requirements of an interactive user interface, in exemplary embodiments of the present invention an optimization iteration can be terminated prematurely by providing a maximum number of possible iterations which an exemplary method will go through.

Because after a few iterations even the simple exemplary cost metric of number of resultant blocks tends to converge more and more slowly, especially when it is near an optimal value, to avoid excessive computations with relatively little improvement, in exemplary embodiments the maximum iteration count can be set, for example, to 3, which strikes a balance between the speed of the optimization algorithm and the quality of the optimization result.

As noted, given the exemplary definition of a tension vector as described above, there is indeed a tendency that all ROI blocks will eventually cramp together. Thus, in exemplary embodiments of the present invention, the definition can be modified to include information about overlap, making the optimization process more robust and efficient.

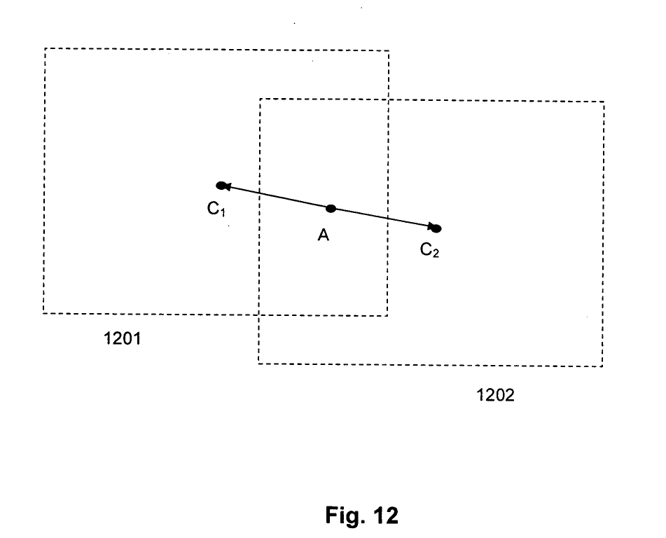

Inasmuch as the current tension vector can be defined, for example, as the vector sum of six component tension vectors (as in the 3D case), one way to fine tune it is to include additional components into the vector sum. For example, when two ROI blocks overlap, a new component vector propelling the two away from one another can be added, thus discouraging excessive overlap. For example, with reference to FIG. 12, a propelling vector can be defined. With reference to FIG. 12 there are shown two voxel blocks, 1201 and 1202, respectively. Point C1 is the center of block 1201, and point C2 the center of block 1202. Point A is the center of the overlapping region of blocks 1201 and 1202. The more overlap, the closer point A is to each of C1 and C2. For every pair of voxel blocks, the propelling vectors between them can be taken as the depicted arrows. The arrows, or propelling vectors, thus connect the center of an overlapping region of the block pair with the center of each block. The greater the values of the propelling vectors the less overlap, and in total overlap the propelling vectors diminish to zero (where A, C1 and C2 converge). To minimize overlap an algorithm could, for example, seek to maximize, increase, or keep above a certain threshold, the values of such propelling vectors.

Once again with reference to FIG. 6, at 635, there are two possible cases: (1) if the maximum number of iterations has not yet been reached, and the new cost metric is better than that obtained from the previous iteration (i.e., c′≈c is NOT true at 635), continue onto the next iteration at 640, setting S equal to S′ and computing the tension vectors for new S (=old S′); or (2) if neither condition is true, terminate the optimization algorithm, and at 645 create voxel blocks with S′ as the bounding boxes. It is noted that the condition c′≈c tests whether the new cost metric is substantially equal to the old one from the prior iteration. Thus, even if there is some improvement by way of lesser cost, but not significant to warrant another iteration, the process can stop and go to 645. In exemplary embodiments of the present invention a user can determine how close is considered too minimal an improvement for continued iteration. For example, decrease of three blocks can be considered as significant, and a further iteration can be run. If a decrease of only 1 or 2 blocks is realized then, for example, the process can stop.

Exemplary Pseudocode

In exemplary embodiments of the present invention, an exemplary algorithm implementing the process flow of FIG. 6 can be implemented using the following exemplary pseudocode.

Initialization

Create regular grid for input volume V as initial bounding boxes, and add them into S

Set cost metric m=∝

Set iteration count i=0

Iteration

i=i+1

Let S′=empty set.

Create a binary volume V_{B} with the same dimensions as the input volume, and initialize all voxels in the ROI region as 1's, the rest voxels as 0's.

For each bounding box bεS,
Compute the tight bounding box b_{T} for the ROI contained in b
Compute 6 component tension vectors v₋ₓ, v₊ₓ, v_{-y}, v_{+y}, v_{-z}, v_{+z} for b
Compute the final tension vector τ_{b}=v₋ₓ+v₊ₓ+v_{-y}+v_{+y}+v_{-z}+v_{+z}
Translate b to b′, such that b′−b=τ_{b}
Inspect the voxels in V_{B} within the bounds of b′
If some voxels bounded by b′ are 1's, set S′=S′∪{b′}
Continue with next block

Compute the new cost metric m′

If i<maximum iterations allowed and m′<m
m=m′, S=S′
Continue with next iteration

Else
Create voxels blocks with bounding boxes in S′
Optimization algorithm completed
   Exemplary Results

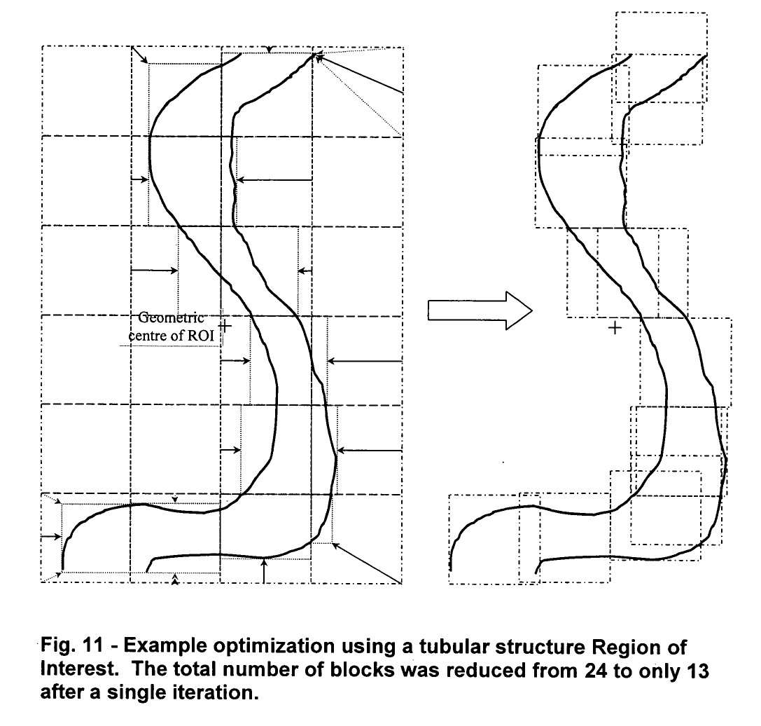

In exemplary embodiments of the present invention, an optimization algorithm can be implemented for visualizations of tube-like structures in large volume data sets, such as, for example, those used in virtual colonoscopy. When operating on such an exemplary tube-like structure, an example of which is shown in FIG. 11, the total number of voxels needed to be rendered can be reduced by 30-60% after optimization according to the methods of exemplary embodiments of the present invention.

For an example similar to that shown in FIG. 11 the following results were obtained:

Data size: 512×512×623 ≈163 million voxels (i.e., 623 CT slices of 512×512 resolution and each voxel was stored in 2 bytes, thus 326.5 MB of raw data, and for processing with shading, 4 times that much, or 1.3 GB)

Optimization block size: 128×128×128

Initial blocks: 80 (equivalent to 128×128×128×80 ≈168 million voxels)

After optimization: 41 (equivalent to 128×128×128×43 ≈86 million voxels)

Total voxel savings ≈(163−86)/163 ≈47%

Using other exemplary data sets of similar size (slice size 512×512, number of slices ranging from 380 to 630) an optimization ratio was computed by running tests on those data sets. There was realized a 20% to 60% saving. For colon datasets, it was found to be in the range of 40-50%.

It is noted that when visualization is restricted to a local region, there are generally only a small number of blocks covering the local portion of the ROI that need to be processed and rendered. This can, in exemplary embodiments of the present invention, further reduce the demand on the graphics acceleration hardware.

For example, in a virtual colonoscopy application, a user's viewpoint is always within the colon lumen. Given the convoluted nature of human colon lumens, only a small portion of the colon lumen is practically visible from any viewpoint within the lumen. In one virtual colonoscopy application implemented by the present inventors, the number of active blocks (blocks that are visible to the user, thus required to be processed for rendering) ranged from 5 to 20 at any one time. In exemplary embodiments of the present invention these active blocks can be identified using well-known geometry intersection algorithms, and can then be marked by a volume renderer. Any block that is not marked as active can, for example, be ignored during the rendering process.

Exemplary Systems

The present invention can be implemented in software run on a data processor, in hardware in one or more dedicated chips, or in any combination of the above. Exemplary systems can include, for example, a stereoscopic display, a data processor, one or more interfaces to which are mapped interactive display control commands and functionalities, one or more memories or storage devices, and graphics processors and associated systems. For example, the Dextroscope™ and Dextrobeam™ systems manufactured by Volume Interactions Pte. Ltd of Singapore, running the RadioDexter™ software, or any similar or functionally equivalent 3D data set interactive display systems, are systems on which the methods of the present invention can easily be implemented.

Exemplary embodiments of the present invention can be implemented as a modular software program of instructions which may be executed by an appropriate data processor, as is or may be known in the art, to implement a preferred exemplary embodiment of the present invention. The exemplary software program may be stored, for example, on a hard drive, flash memory, memory stick, optical storage medium, or other data storage devices as are known or may be known in the art. When such a program is accessed by the CPU of an appropriate data processor and run, it can perform, in exemplary embodiments of the present invention, methods as described above of optimizing the display of a 3D computer model in a 3D data display system.

While this invention has been described with reference to one or more exemplary embodiments thereof, it is not to be limited thereto and the appended claims are intended to be construed to encompass not only the specific forms and variants of the invention shown, but to further encompass such as may be devised by those skilled in the art without departing from the true scope of the invention.

What is claimed is:

1. A method of optimizing the volume rendering of a 3D data set containing a ROI, comprising:
dividing a region of interest into a set of blocks S;
computing a tension vector for each block;
translating each block as a function of its respective tension vector; and
removing any empty and/or redundant blocks to create a new set of blocks S′.

2. The method of claim 1, further comprising computing a cost metric for each of S and S′.

3. The method of claim 1, wherein the process is repeated until a defined condition is reached.

4. The method of claim 3, wherein the defined condition is a fixed number of iterations having occurred.

5. The method of claim 2, wherein the process is repeated until a defined condition is reached.

6. The method of claim 5, wherein the defined condition is the cost metric for S′ being at least one of: substantially equal to the cost metric for S, less than the cost metric for S by a given value, less than the cost metric for S by a given percentage, and a defined value.

7. The methods of any of claims 1-6, wherein a magnitude of a tension vector is defined as the distance between a farthest point on a block from a ROI and the closest corner of a tight bounding box for the portion of the ROI in that block.

8. The method of claim 7, wherein said magnitude further comprises a term representing an index of overlap between that block and other blocks in S.

9. The method of claim 8, wherein the function of the tension vector is the identity function.

10. The method of claim 8, wherein the function of the tension vector is the identity function plus an index of overlap.

11. The method of claim 9, wherein the 3D data set is rendered by only rendering blocks in S′.

12. The method of claim 1, wherein the blocks are rectangular and axis-aligned.

13. The method of claim 1, wherein the dimensions of the blocks are domain specific.

14. The method of claim 2, wherein the cost metric is a function of the characteristics of the ROI.

15. The method of claim 1, wherein the ROI is viewpoint-dependent.

16. A method of dynamically deleting non-contributory voxels from a 3D data set prior to rendering an ROI within it, comprising: dividing the 3D data set into a set of blocks; identifying empty or redundant blocks and deleting them form the set; and rendering the set of blocks.

17. A computer program product comprising a computer usable medium having computer readable program code means embodied therein, the computer readable program code means in said computer program product comprising means for causing a computer to:
divide a region of interest into a set of blocks S;
compute a tension vector for each block;
translate each block as a function of its respective tension vector; and
remove any empty and/or redundant blocks to create a new set of blocks S′.

18. The computer program product of claim 17, further comprising causing a computer to compute a cost metric for each of S and S′.

19. The computer program product of claim 17, wherein the process is repeated until a defined condition is reached.

20. The computer program product of claim 17, wherein the defined condition is a fixed number of iterations having occurred.

21. The computer program product of claim 17, wherein the process is repeated until a defined condition is reached.

22. The computer program product of claim 17, wherein the defined condition is the cost metric for S′ being at least one of: greater than the cost metric for S, greater than the cost metric for S by a given value, greater than the cost metric for S by a given percentage, and a defined value.

23. The method of any of claims 1-6, wherein S′<S.

24. The method of any of claims 1-6, wherein the block size of S and S′ is arranged to have a block easily fit within a texture memory used for the volume rendering.

25. The method of claim 24, wherein a block's dimensionality d³ is set to be less than the size of said texture memory.
